(19) United States
(12) Patent Application Publication
(10) Pub. No.: US 2014/0207737 A1
(43) Pub. Date: Jul. 24, 2014

(54) METHOD AND APPARATUS FOR SYNCHRONIZING KNOWLEDGE SERVICE

(71) Applicant: Electronics and Telecommunications Research Institute, Daejeon (KR)

(72) Inventors: Inhak JOO, Daejeon (KR); Seung-Ik LEE, Chungcheongbuk-do (KR); RockWon KIM, Daejeon (KR); Yun Kyung PARK, Daejeon (KR); Chae Kyu KIM, Daejeon (KR)

(73) Assignee: Electronics and Telecommunications Research Institute, Daejeon (KR)

(21) Appl. No.: 14/021,896

(22) Filed: Sep. 9, 2013

(30) Foreign Application Priority Data
Jan. 24, 2013 (KR) 10-2013-0008284

(51) Int. Cl. G06F 17/30

(52) U.S. Cl. CPC G06F 17/30575
USPC 707/634

(57) ABSTRACT

A knowledge service synchronization apparatus transmits a knowledge request message from a knowledge consumer to a knowledge server, receives a knowledge response message to the knowledge request message from the knowledge server, and outputs knowledge contents that the knowledge consumer requests. In this case, when the knowledge response message is an update message including updated knowledge contents, the knowledge service synchronization apparatus determines an output of knowledge contents of the update message according to whether the knowledge consumer wants to receive updated knowledge.

### CROSS-REFERENCE TO RELATED APPLICATION

This application claims priority to and the benefit of Korean Patent Application No. 10-2013-0008284 filed in the Korean Intellectual Property Office on Jan. 24, 2013, the entire contents of which are incorporated herein by reference.

### BACKGROUND OF THE INVENTION

(a) Field of the Invention

The present invention relates to a method and apparatus for synchronizing a knowledge service. More particularly, the present invention relates to a method and apparatus for synchronizing a knowledge service that can use updated knowledge without repeatedly requesting knowledge after a client device, which is a knowledge consumer, requests and uses knowledge.

(b) Description of the Related Art

Many techniques for servicing knowledge online have been suggested. Knowledge services that have been suggested thus far are mostly performed with a method in which knowledge providers upload knowledge to a server and knowledge consumers search for knowledge and obtain a search result, and a method in which knowledge consumers register a question and a plurality of knowledge providers view a question list and register an answer thereof, and then the knowledge consumer views again, adapts, and consumes the answer.

In such methods, because circulation of knowledge is disposable, in order to supplement this, a method of determining whether an additional answer is registered later and contacting and transmitting the additional answer to the knowledge consumer that registered the question has been suggested. When first registering the question, the knowledge consumer who registers the question sets whether to receive notification if an additional answer is registered.

Further, in order to synchronize data that an individual uses between a server and a mobile device, technology of using a synchronization server is widely used. Various cloud services provide data management by synchronization and a trigger mechanism for web data, social media data, e-mail, text messages, and other individual generation data. However, in most cases, the cloud services provide static data synchronization of individual data.

In case of an answer in which obtains from the outside by asking a question instead of data that the user directly inputs, when the answer no longer has a meaning or is changed in addition to synchronization between devices, the answer should be generated and updated again.

Nowadays, because knowledge is consumed as a one-off, the user views the knowledge once and is then no longer interested in the knowledge. One-off knowledge exists, but in real life, whenever a meaning of information is changed, the most of knowledge is changed, and then the most of knowledge has meaning.

If the knowledge in which the meaning is disappears is not updated, various problems may occur due to wrong information. However, in a situation in which the user does not know whether the meaning of information is changed, it is not efficient to repeatedly ask the same question.

For example, when civil affairs administration of government and public offices or business hours of a bank are changed, many customers do not immediately know of change of such information and thus may suffer inconvenience.

In order to notify a user of such an information change, a method of transmitting a text message to the user when an individual service is changed has been used. However, a service change is generally individually notified in the form of an e-mail or a text message, so information that is unnecessary for the user may be forwarded, and thus the user may suffer inconvenience. Further, such a method often has a form of advertisement and is generally provided by a service provider's determination, and thus the service provider may not know information change necessary for the user and thus much information may be unnecessarily provided.

### SUMMARY OF THE INVENTION

The present invention has been made in an effort to provide a method and apparatus for synchronizing a knowledge service having advantages of effectively providing updated knowledge to a knowledge consumer, even if the knowledge consumer does not request knowledge again.

An exemplary embodiment of the present invention provides a method of synchronizing and providing knowledge that a knowledge consumer requests in a knowledge service synchronization apparatus. The method includes: receiving a knowledge response message to request knowledge from the knowledge consumer from a knowledge server; determining whether knowledge contents of the knowledge response message are updated knowledge; and outputting, when the knowledge consumer requests to receive updated knowledge, the updated knowledge.

The method may further include: receiving a knowledge request message from the knowledge consumer; and transmitting the knowledge request message to the knowledge server, wherein the knowledge request message may include an identifier of the knowledge request message, requested knowledge, and information on whether to receive the updated knowledge.

The knowledge request message may further include a receiving condition of the updated knowledge.

The outputting of the updated knowledge may include outputting, when the receiving condition of the update knowledge is satisfied, the updated knowledge to the knowledge consumer.

The knowledge request message may further include a receiver of the updated knowledge.

The outputting of the updated knowledge may include outputting the updated knowledge to the receiver.

The receiving of a knowledge request message may include storing, when a knowledge request message that is set to request to receive the updated knowledge is received, the requested knowledge together with an identifier of the knowledge request message at a knowledge synchronization storage.

The knowledge response message may include an identifier of the knowledge request message, knowledge contents, and a response version, and the determining may include determining whether the knowledge contents of the knowledge response message are the updated knowledge contents from the response version.

The method may further include storing the knowledge contents of the knowledge response message together with the identifier of the knowledge request message at a knowledge storage.

The method may further include outputting knowledge contents of the knowledge response message when the knowledge response message is a first response to the knowledge request.

Another embodiment of the present invention provides an apparatus for synchronizing and providing knowledge that a knowledge consumer requests. The knowledge service synchronization apparatus includes a transmitter, a receiving unit, an outputter, and a determiner. The transmitter transmits a knowledge request message from the knowledge consumer to a knowledge server. The receiver receives a knowledge response message to the knowledge request message from the knowledge server. The outputter outputs knowledge contents that the knowledge consumer requests. The determiner determines whether the knowledge response message is an update message and determines an output of knowledge contents of the update message according to whether updated knowledge of the knowledge consumer is received.

The knowledge request message may include an identifier of the knowledge request message, requested knowledge, and information on whether to receive the updated knowledge.

The knowledge response message may include an identifier of the knowledge request message, knowledge contents, and a response version, and the determiner may determine whether the knowledge response message from the response version is the update message.

The knowledge service synchronization apparatus may further include a synchronization manager. The synchronization manager may store the requested knowledge together with the identifier of the knowledge request message at a knowledge synchronization storage, when receiving the knowledge request message that is set to receive the updated knowledge.

When the response message is the update message, if the same identifier as that of the knowledge request message in the knowledge response message exists at the knowledge synchronization storage, the determiner may determine that the knowledge consumer receives updated knowledge.

The determiner may store knowledge contents of the knowledge response message at a knowledge storage together with the identifier of the knowledge request message and notify the outputter that the knowledge is updated, when the knowledge request message is the update message, and the outputter may output the updated knowledge contents when the outputter receives information that the knowledge contents are updated from the determiner.

The knowledge service synchronization apparatus may be formed in a client device of the knowledge consumer.

### BRIEF DESCRIPTION OF THE DRAWINGS

FIG. 1 is a block diagram illustrating a knowledge service synchronization apparatus according to an exemplary embodiment of the present invention.

FIG. 2 is a diagram illustrating an example of a knowledge request message according to an exemplary embodiment of the present invention.

FIG. 3 is a diagram illustrating an example of a knowledge response message according to an exemplary embodiment of the present invention.

FIG. 4 is a flowchart illustrating a method of providing knowledge in a knowledge service synchronization apparatus according to an exemplary embodiment of the present invention.

FIG. 5 is a flowchart illustrating a method of synchronizing update knowledge in a knowledge service synchronization apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for synchronizing a knowledge service according to an exemplary embodiment of the present invention will be described in detail with reference to the drawings.

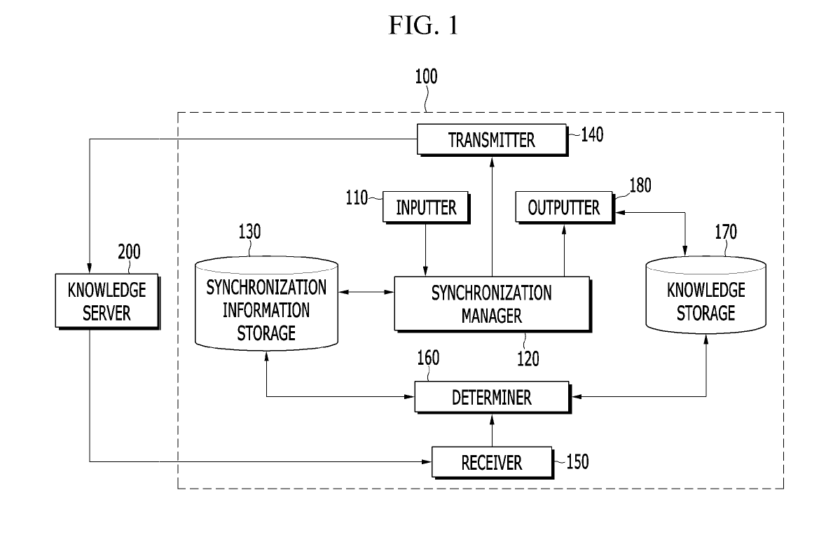

FIG. 1 is a block diagram illustrating a knowledge service synchronization apparatus according to an exemplary embodiment of the present invention.

Referring to FIG. 1, a knowledge service synchronization apparatus 100 is connected to a knowledge server 200, and may be connected to the knowledge server 200, for example, through a network. The knowledge service synchronization apparatus 100 may be formed in a client device such as a computer and a mobile terminal of a knowledge consumer. The knowledge consumer is a user using a knowledge service, but may indicate an individual or a corporation.

The knowledge server 200 receives knowledge from a knowledge provider and stores and manages the received knowledge. The knowledge provider provides data, information, or knowledge and provides knowledge in a form such as upload, transmission, or offline to the knowledge server 200, and when the provided knowledge is updated, the knowledge provider may provide the updated knowledge.

When the provided knowledge is updated, the knowledge server 200 transmits the updated knowledge to the knowledge service synchronization apparatus 100.

The knowledge service synchronization apparatus 100 requests knowledge from the knowledge server 200, receives the requested knowledge from the knowledge server 200, and outputs the knowledge to the knowledge consumer. Further, the knowledge service synchronization apparatus 100 outputs the updated knowledge to the knowledge consumer according to whether the knowledge consumer receives updated knowledge. Reception of updated knowledge represents synchronization of knowledge.

The knowledge service synchronization apparatus 100 includes an inputter 110, a synchronization manager 120, a synchronization information storage 130, a transmitter 140, a receiver 150, a determiner 160, a knowledge storage 170, and an outputter 180.

The inputter 110 receives an input of a knowledge request message from the knowledge consumer. The knowledge request message includes information on whether to synchronize knowledge. That is, when knowledge is updated later, the knowledge consumer determines whether to receive the updated knowledge, i.e., whether to synchronize knowledge, and inputs a knowledge request message on whether synchronization is set to the inputter 110. Further, the knowledge consumer may set a receiver of updated knowledge. In this case, the knowledge request message may further include receiver information of updated knowledge.

The synchronization manager 120 analyzes the knowledge request message, and when knowledge synchronization is set in the knowledge request message, the synchronization manager 120 stores the knowledge request message in the synchronization information storage 130 and forwards the knowledge request message to the transmitter 140.

The information storage 130 stores a knowledge request message in which knowledge synchronization is set.

The transmitter 140 forwards the knowledge request message to the knowledge server 200.

The receiver 150 receives a knowledge response message including knowledge that the knowledge consumer requests from the knowledge server 200, and forwards the knowledge response message to the determiner 160.

When the determiner 160 receives the knowledge response message from the knowledge server 200, the determiner 160 stores knowledge contents of the knowledge response message to the knowledge storage 170 and forwards the knowledge contents to the outputter 180. The knowledge response message includes a message that the knowledge consumer first received from the knowledge server 200 after the knowledge consumer requested knowledge, and a message from the knowledge server 200 when knowledge that the knowledge consumer requested is updated. A message that is first received from the knowledge server 200 is referred to as an initial message, and a message that is received from the knowledge server 200 when knowledge that the knowledge consumer requested is updated is referred to as an update message.

The knowledge storage 170 stores knowledge contents that are received from the knowledge server 200.

The outputter 180 outputs, i.e., consumes, knowledge contents that the knowledge consumer requests. “To consume” includes an operation such as expressing a knowledge request result through a viewer such as an App or a web browser in a client device, transmitting the result to another service, and generating new knowledge by statistical analysis, and may be variously performed according to a form of an actual application.

The inputter 110 and the outputter 180 may provide message input/output and information expression by a simple user interface, and may be formed as an internal module within one program or application. The inputter 110 and the outputter 180 may be the same or different.

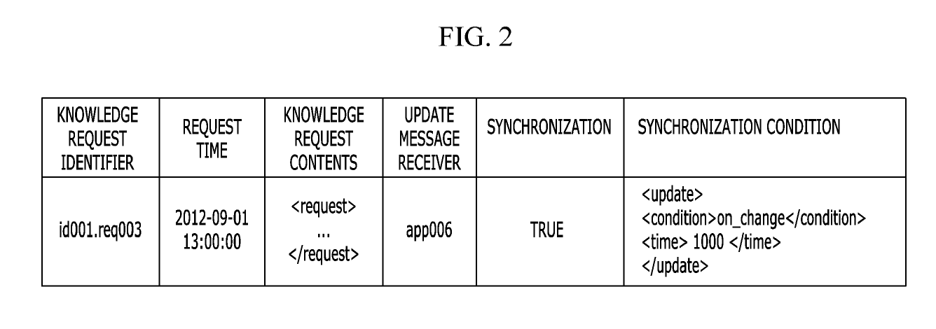

FIG. 2 is a diagram illustrating an example of a knowledge request message according to an exemplary embodiment of the present invention.

Referring to FIG. 2, the knowledge request message includes a knowledge request identifier field, a request time field, a knowledge request content field, an update message receiver field, a synchronization field, and a synchronization condition field.

The knowledge request identifier field includes a knowledge request identifier (e.g., id023.req005) for identifying a knowledge request message. The knowledge request identifier may be generated by combining an identifier of a client device and a serial number that is given by the synchronization manager 120. When the knowledge request identifier is id023.req005, id023 may be an identifier of the client device, and req005 may be a serial number that is given by the synchronization manager 120.

The request time field includes a time (e.g., 13:00:00, Sep. 1, 2012) when the knowledge consumer requests knowledge.

The knowledge request content field includes knowledge contents that the knowledge consumer requests.

The update message receiver field includes an identifier (e.g., app066) of a receiver of an update message. The update message receiver field sets a receiver to receive and consume the updated knowledge. The receiver of the update message may be a program or App that generally generates a first knowledge request message, and other software may be a receiver of an update message.

The synchronization field includes information on whether the knowledge consumer synchronizes knowledge. The synchronization field may be set to a numeral such as 0 or 1, or may be set to text such as true or false. For example, when the knowledge consumer requests to receive update knowledge, the synchronization field may be set to true, and when the knowledge consumer does not request to receive update knowledge, the synchronization field may be set to false. Alternatively, when the knowledge consumer requests to receive update knowledge, the synchronization field may be set to 1, and when the knowledge consumer does not request to receive update knowledge, the synchronization field may be set to 0.

The synchronization condition field includes a receiving condition of an update message. For example, the knowledge consumer may set a temporal condition and a spatial condition as a receiving condition of the update message. For example, the knowledge consumer may set a predetermined condition such as when 1 year has elapsed, when the knowledge consumer goes to a foreign country, or when the knowledge consumer moves a distance of 100 km or more from a first request location. In this way, when the knowledge consumer sets a receiving condition of an update message, such receiving condition information is set to the synchronization condition field. When a particular condition does not exist, the synchronization condition field is set to 0 or left blank.

When the synchronization manager 120 receives such a knowledge request message, the synchronization manager 120 analyzes the knowledge request message, and when the knowledge consumer requests synchronization of knowledge, the synchronization manager 120 stores knowledge request contents, a receiving condition of an update message, and a receiver identifier of an update message together with a knowledge request identifier at the synchronization information storage 130.

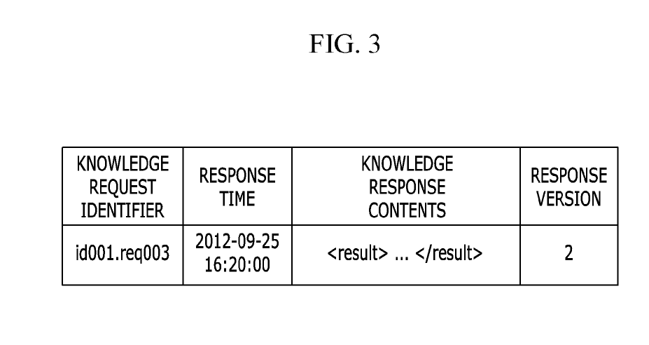

FIG. 3 is a diagram illustrating an example of a knowledge response message according to an exemplary embodiment of the present invention.

Referring to FIG. 3, the knowledge response message includes a knowledge request identifier field, a response time field, a knowledge response content field, and a response version field.

The knowledge request identifier field includes a knowledge request identifier for identifying a knowledge request message. It can be seen that the knowledge response message is a response to the knowledge request message through the knowledge request identifier of the knowledge request identifier field. For example, when the knowledge response message is a response to the knowledge request message like in FIG. 2, the knowledge request identifier field of the knowledge response message may be set to id023.req005.

The response time field includes a response time (e.g., 16:20:00, Sep. 25, 2012) of the knowledge request message in the knowledge server 200.

The knowledge response content field includes contents of knowledge that is provided in the knowledge server 200.

The response version field includes information representing whether the knowledge response message is an initial message or an update message. That is, it can be seen that knowledge is updated from a value of a response version field. For example, the response version field may represent the number of number of transmissions of a knowledge response message to the knowledge request message, and when a value of the response version field is not 1, it may represent that knowledge is updated. That is, when a value of the response version field is 1, the value 1 represents an initial message, which is a first response, and when a value of the response version field is 2 or 3, the value 2 or 3 may represent an update message, which is a second or third response to the knowledge request message.

When such a knowledge response message is received, the determiner 160 analyzes the knowledge response message. When the knowledge response message is an update message, the determiner 160 stores a response time, knowledge response contents, and a response version together with a knowledge request identifier at the knowledge storage 170.

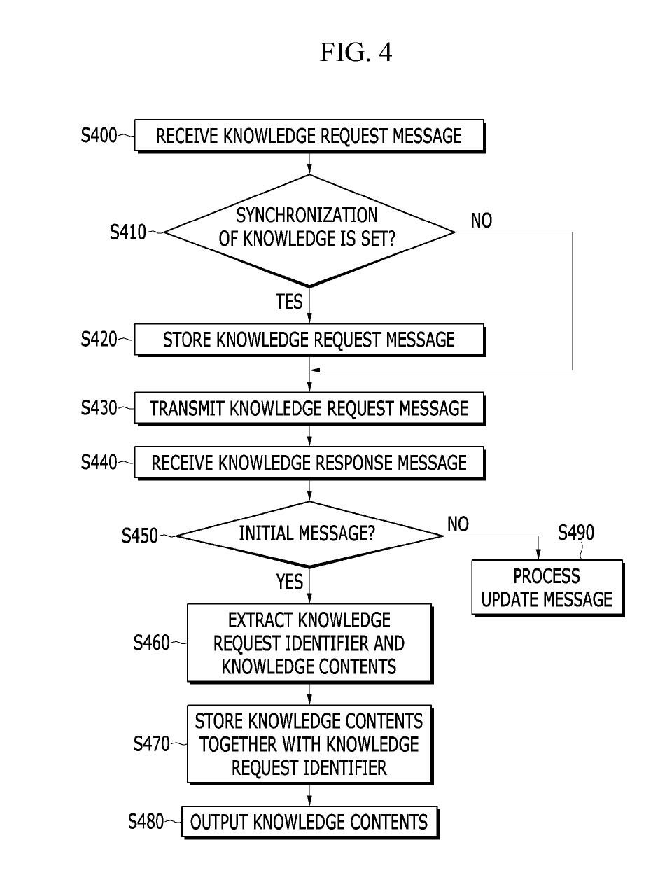

FIG. 4 is a flowchart illustrating a method of providing knowledge in a knowledge service synchronization apparatus according to an exemplary embodiment of the present invention.

Referring to FIG. 4, the inputter 110 of the knowledge service synchronization apparatus 100 receives a knowledge request message from a knowledge consumer (S400). The inputter 110 forwards the knowledge request message to the synchronization manager 120.

The synchronization manager 120 analyzes the knowledge request message and determines whether synchronization of knowledge is set (S410). Synchronization of knowledge may be determined from a value of a synchronization field of the knowledge request message.

If synchronization of knowledge is set in the knowledge request message, the synchronization manager 120 stores the knowledge request message at the synchronization information storage 130 (S420) and forwards the knowledge request message to the transmitter 140. The synchronization manager 120 may store an entire knowledge request message or only a portion of a knowledge request message. For example, the synchronization manager 120 may store all or some of knowledge request contents together with a knowledge request identifier, a receiving condition of an update message, and a receiver identifier of an update message.

If reception of update knowledge is not set to the knowledge request message, the synchronization manager 120 forwards the knowledge request message to the transmitter 140 without step S420 of storing the knowledge request message.

The transmitter 140 transmits the knowledge request message to the knowledge server 200 (S430).

The receiver 150 receives knowledge in which the knowledge consumer requests from the knowledge server 200 through the knowledge response message (S440). Knowledge from the knowledge server 200 may be received through the knowledge response message. The receiver 150 forwards the knowledge response message to the determiner 160.

The determiner 160 analyzes the knowledge response message and determines whether the knowledge response message is an initial message or an update message (S450).

If the knowledge response message is an initial message, the determiner 160 extracts a knowledge request identifier and knowledge contents from the knowledge response message (S460), and stores the knowledge contents together with the knowledge request identifier at the knowledge storage 170 (S470). The determiner 160 forwards the knowledge contents to the outputter 180.

The outputter 180 outputs the knowledge contents (S480).

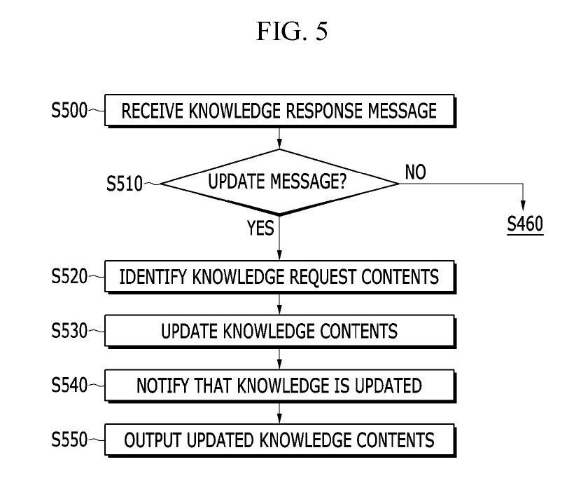

When the knowledge response message is an update message, the determiner 160 processes the update message (S490), and a method of processing the update message will be described with reference to FIG. 5.

FIG. 5 is a flowchart illustrating a method of synchronizing update knowledge in a knowledge service synchronization apparatus according to an exemplary embodiment of the present invention.

Referring to FIG. 5, when the receiver 150 receives a knowledge response message from the knowledge server 200 (S500), the receiver 150 transmits the knowledge response message to the determiner 160.

The determiner 160 analyzes the knowledge response message and determines whether the knowledge response message is an initial message or an update message (S510).

If the knowledge response message is an update message, the determiner 160 searches for the synchronization information storage 130 through a knowledge request identifier in the knowledge response message to identify corresponding knowledge request contents (S520), and updates knowledge contents that are stored to correspond to the knowledge request identifier at the knowledge storage 170 (S530). That is, the determiner 160 updates knowledge contents that are stored to correspond to the knowledge request identifier to knowledge contents in the update message.

Next, the determiner 160 forwards a knowledge response message which is an update message to the synchronization manager 120, and the synchronization manager 120 determines whether to synchronize and identifies an update message receiver from data that is stored at the synchronization information storage 130 and thus notifies the outputter 180 that new knowledge is updated (S540).

When update notification of knowledge is received from the determiner 160, the outputter 180 accesses the knowledge storage 170 and outputs and consumes the updated knowledge contents (S550).

When update of knowledge occurs, a method in which the synchronization manager 120 transmits a notification message to the outputter 180 is as described, but a method in which the outputter 180 searches for update of new knowledge may be changed and performed like the next method.

For example, it is assumed that the outputter 180 is a program or an applied application. When the outputter 180 is initially executed, the outputter 180 searches for knowledge update particulars of the synchronization manager 120 for a necessary knowledge request identifier, and if a search result exists, the outputter 180 may access the knowledge storage 170 and bring the corresponding knowledge by the knowledge request identifier. The outputter 180 periodically searches for knowledge update particulars of the synchronization manager 120 for a necessary knowledge request identifier while executing, and if a search result exists, the outputter 180 may access the knowledge storage 170 and bring the corresponding knowledge by the knowledge request identifier.

Alternatively, when new knowledge is updated, the synchronization manager 120 may broadcast a corresponding knowledge request identifier. Accordingly, the outputter 180 accesses the knowledge storage 170 to bring knowledge contents corresponding to the knowledge request identifier.

At step S560 of outputting the updated knowledge, the knowledge consumer can generally obtain updated knowledge without an additional operation of separately requesting knowledge. Update of knowledge by the above-described steps S510-S550 is executed in the background, and when the knowledge consumer again views an expression form of a document or knowledge later, the knowledge consumer may automatically view changed contents. When the knowledge consumer views the document again, there may be a limitation in determining whether the document is changed from previous contents, and thus for convenience of the knowledge consumer, the outputter 180 may auxiliarily output update time information of the knowledge.

According to an exemplary embodiment of the present invention, when a knowledge consumer who requests knowledge and receives a knowledge service sets a request to send updated knowledge when knowledge is updated upon requesting knowledge instead of repeatedly requesting knowledge, whenever information is updated, information or knowledge can be provided to the user by a push method. That is, after a knowledge consumer requests knowledge and receives an answer, when information of the answer is updated, if the knowledge consumer does not request knowledge again, the knowledge consumer cannot know updates of the knowledge, and the knowledge consumer may not know that the answer may have no meaning or has become wrong knowledge. A knowledge service synchronization apparatus according to the present invention can prevent this and always provide the newest and most updated knowledge to the knowledge consumer.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of synchronizing and providing knowledge that a knowledge consumer requests in a knowledge service synchronization apparatus, the method comprising:
receiving a knowledge response message to request knowledge from the knowledge consumer from a knowledge server;
determining whether knowledge contents of the knowledge response message are updated knowledge; and
outputting, when the knowledge consumer requests to receive updated knowledge, the updated knowledge.

2. The method of claim 1, further comprising:
receiving a knowledge request message from the knowledge consumer; and
transmitting the knowledge request message to the knowledge server,
wherein the knowledge request message comprises an identifier of the knowledge request message, requested knowledge, and information on whether to receive the updated knowledge.

3. The method of claim 2, wherein the knowledge request message further comprises a receiving condition of the updated knowledge.

4. The method of claim 3, wherein the outputting of the updated knowledge comprises outputting, when the receiving condition of the update knowledge is satisfied, the updated knowledge to the knowledge consumer.

5. The method of claim 2, wherein the knowledge request message further comprises a receiver of the updated knowledge.

6. The method of claim 5, wherein the outputting of the updated knowledge comprises outputting the updated knowledge to the receiver.

7. The method of claim 2, wherein the receiving of a knowledge request message comprises storing, when a knowledge request message that is set to request to receive the updated knowledge is received, the requested knowledge together with an identifier of the knowledge request message at a knowledge synchronization storage.

8. The method of claim 1, wherein the knowledge response message comprises an identifier of the knowledge request message, knowledge contents, and a response version, and
the determining comprises determining whether the knowledge contents of the knowledge response message from the response version are the updated knowledge contents.

9. The method of claim 8, further comprising storing the knowledge contents of the knowledge response message together with the identifier of the knowledge request message at a knowledge storage.

10. The method of claim 1, further comprising outputting knowledge contents of the knowledge response message when the knowledge response message is a first response to the knowledge request.

11. The method of claim 1, wherein the knowledge service synchronization apparatus is formed in a client device of the knowledge consumer.

12. An apparatus for synchronizing and providing knowledge that a knowledge consumer requests, the apparatus comprising:
a transmitter that transmits a knowledge request message from the knowledge consumer to a knowledge server;
a receiver that receives a knowledge response message to the knowledge request message from the knowledge server;
an outputter that outputs knowledge contents that the knowledge consumer requests; and
a determiner that determines whether the knowledge response message is an update message and that determines an output of knowledge contents of the update message according to whether updated knowledge of the knowledge consumer is received.

13. The apparatus of claim 12, wherein the knowledge request message comprises an identifier of the knowledge request message, requested knowledge, and information on whether to receive the updated knowledge.

14. The apparatus of claim 12, wherein the knowledge response message comprises an identifier of the knowledge request message, knowledge contents, and a response version, and
the determiner determines whether the knowledge response message is the update message from the response version.

15. The apparatus of claim 14, further comprising a synchronization manager that stores the requested knowledge together with the identifier of the knowledge request message at a knowledge synchronization storage, when receiving the knowledge request message that is set to receive the updated knowledge.

16. The apparatus of claim 15, wherein the determiner determines that the knowledge consumer receives updated knowledge, if the same identifier as that of the knowledge request message in the knowledge response message exists at the knowledge synchronization storage, when the response message is the update message.

17. The apparatus of claim 12, wherein the knowledge request message comprises a receiving condition of the updated knowledge, and
the outputter outputs the updated knowledge to the knowledge consumer, when a receiving condition of the updated knowledge is satisfied.

18. The apparatus of claim 12, wherein the determiner stores knowledge contents of the knowledge response message at a knowledge storage together with the identifier of the knowledge request message and notifies the outputter that the knowledge is updated, when the knowledge request message is the update message, and
the outputter outputs the updated knowledge contents when the outputter receives information that the knowledge contents are updated from the determiner.

19. The apparatus of claim 12, wherein the knowledge service synchronization apparatus is formed in a client device of the knowledge consumer.
